(19) United States
(12) Patent Application Publication
(10) Pub. No.: US 2014/0091076 A1
(43) Pub. Date: Apr. 3, 2014

(54) HEATING DEVICE FOR MOTORCYCLE SUITS

(71) Applicant: CHIEN-CHOU CHEN, TAINAN CITY (TW)

(72) Inventor: CHIEN-CHOU CHEN, TAINAN CITY (TW)

(21) Appl. No.: 13/629,960

(22) Filed: Sep. 28, 2012

(51) Int. Cl. H05B 3/00

(52) U.S. Cl. 219/211

(57) ABSTRACT

A heating device for motorcycle suits includes a heating pad located in the suit, and a temperature controller and a switch are separated from each other. The switch is located at the position where the user can easily access. When a user wants to operate the heating device, and/or adjust the temperature of the heating pad, the temperature controller and the switch are easily accessed and operated.

### BACKGROUND OF THE INVENTION

1. Fields of the Invention

The present invention relates to a heating device for motorcycle suits, and more particularly, to a heating device with separated controller and switch for convenient operation.

2. Descriptions of Related Art

The conventional heating device 8 for motorcycle suits is disclosed in FIG. 7 and generally comprises a heating pad 81 connected to the suit 9. A wire 82 is connected between the heating pad 81 and a temperature controller 83 which is located outside of the suit 9. Another wire 82 is connected between the temperature controller 83 and the battery of the motorcycle. By operation to the button or knob on the temperature controller 83, a correspondent temperature regulation member 831 is activated to active the circuit to adjust the current from the battery to the heating pad 81 so as to adjust the temperature of the heating pad 81.

The conventional heating device 8 includes the power input wire and the power output wire so as to deliver high current, however, the power input wire and the power output wire are bulky and occupy a certain space in the suit 9 and which makes the user feel uncomfortable. Besides, the temperature controller 83 includes thyristor members, micro-processing members and the temperature regulation buttons so that it is heavy and is not suitable to be connected to the sleeves. Therefore, the temperature controller 83 is put in the pocket or attached to the user's waist. When the user wants to operate the temperature controller 83, the user has to pick it out from the pocket or belt and this action may cause accident.

The present invention intends to provide a heating device for motorcycle suits, and the temperature controller and the switch are separated. The switch is located at the position where the user can easily access.

### SUMMARY OF THE INVENTION

The present invention relates to a heating device for motorcycle suits, and comprises a heating pad installed in the suit and a controller is fixed to the suit and has a circuit board which is connected with a power input member and a thyristor member which is connected to the power input member. The thyristor member is connected with the heating pad by a wire. A micro-processing device is connected to the circuit board and connected with the thyristor member and the power input member. The micro-processing device is connected to a circuit board of a switch by a wire. The wire connected between the controller and the switch, and the wire connected between the controller and the heating pad is located in the suit.

The switch is located separated from the controller and is connected to the suit. The circuit board of the switch has a temperature regulation button and a temperature display member connected thereto. The temperature regulation button and the temperature display member are connected to the micro-processing device of the controller by the circuit board of the switch.

The primary object of the present invention is to provide a heating device for motorcycle suits. The temperature controller and the switch button are separated. The switch button is located at the position where the user can easily access.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the heating device of the present invention connected to the suit;

FIG. 2 shows the connection relationship of the parts of the heating device of the present invention;

FIG. 3 shows the second embodiment of the heating device of the present invention connected to the suit;

FIG. 4 shows the controller and the signal receiver of the second embodiment of the heating device of the present invention;

FIG. 5 shows the signal emitter and the connection relationship of the parts of the second embodiment of the heating device of the present invention;

FIG. 6 shows the controller and the signal receiver of the third embodiment of the heating device of the present invention, and

FIG. 7 shows the controller of the conventional heating device connected to the battery of the motorcycle.

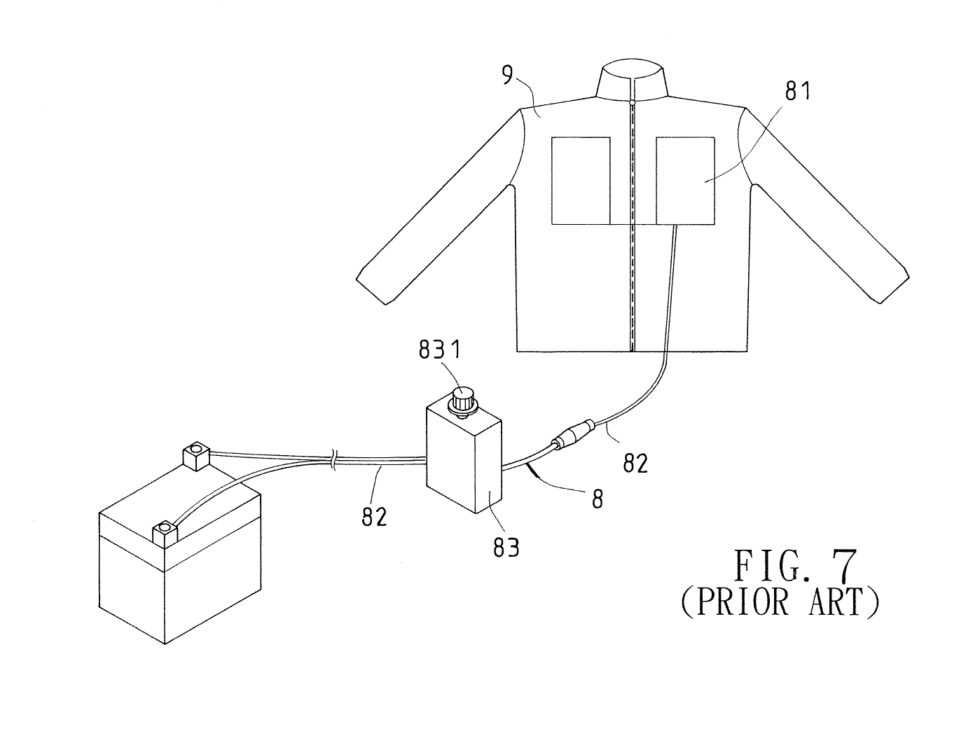

### DETAILED DESCRIPTION OF THE PREFERRED EMBODIMENT

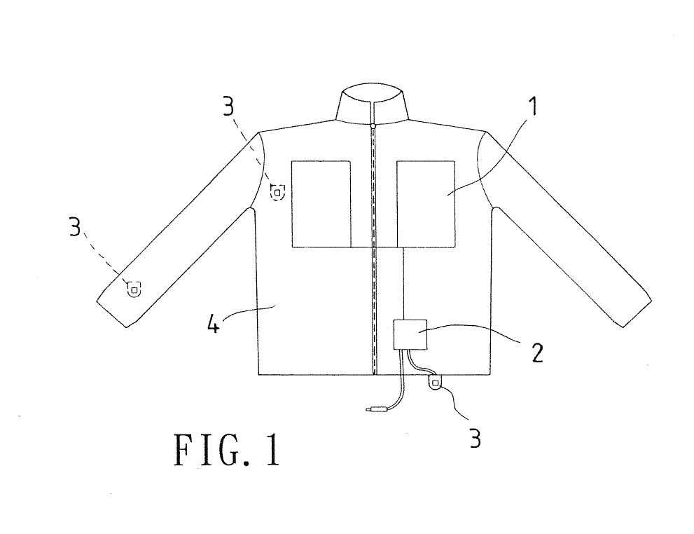

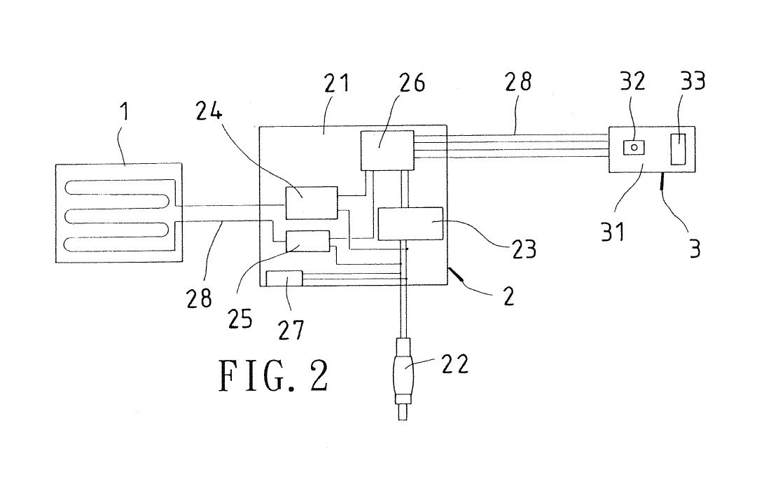

Referring to FIGS. 1 and 2, the heating device for motorcycle suits of the present invention comprises a heating pad 1, a controller 2 and a switch 3.

The heating pad 1 is installed in the suit 4 and the controller 2 is fixed to the suit 4. Preferably, the controller 2 is fixed to the lower portion of the suit 4. The controller 2 has a circuit board 21 to which a power input member 22, in the form of a plug or receptacle is connected. A voltage reduction member 23, a thyristor member 24 and a current detection member 25 are connected to the circuit 21 and, all of the voltage reduction member 23, the thyristor member 24 and the current detection member 25 are connected to the power input member 22. The thyristor member 24 can be Metal-Oxide-Semiconductor Field-Effect Transistor (MOSFET). The thyristor member 24 and the current detection member 25 are connected to the heating pad 1 by a wire 28 of the current detection member 25. The circuit board 21 further has a micro-processing device 26 connected thereto which is connected with the thyristor member 24 and the voltage reduction member 23. The micro-processing device 26 is further connected to a circuit board 31 of a switch 3 by a wire 28. The wire 28 connected between the controller 2 and the switch 3, and the wire 28 connected between the controller 2 and the heating pad 1 are located in the suit 4. The circuit board 21 of the controller 2 has at least one power output member 27 which is connected to the power input member 22.

The switch 3 is located separated from the controller 2 and connected to the sleeve, front chest portion or the lower portion of the suit 4. The circuit board 31 of the switch 3 has a temperature regulation button 32 and a temperature display member 33 connected thereto. The temperature regulation button 32 and the temperature display member 33 are connected to the micro-processing device 26 of the controller 2 by the circuit board 31 of the switch 3. The temperature display member 33 can be a liquid crystal display, digital tubes, bar index lights or multiple light emitters which changes colors according the temperature.

When in use, the current input member 22 of the controller 2 is connected with the battery of the motorcycle, and the temperature regulation button 32 is connected to the sleeve, front chest portion or the lower portion of the suit 4. By pressing the temperature regulation button 32 for 2-3 seconds, the circuit board 31 is activated and sends the long-pressing signal to the micro-processing device 26 of the controller 2 via the wire 28. The micro-processing device 26 activates the thyristor member 24 so that the current flows to the heating pad 1 along the wire 28 via the thyristor member 24 so that the heating pad 1 transfers the electric energy into heat energy to warm the user's body.

When the user presses the temperature regulation button 32 to drive the micro-processing device 26 to activate the thyristor member 24, the micro-processing device 26 sends a signal to the temperature display member 33 of the switch 3 via the wire 28 to show that the thyristor member 24 is opened. When the user wants to adjust the temperature of the heating pad 1, the temperature regulation button 32 is pressed for 1-2 seconds, the circuit board 31 is activated and sends the short-pressing signal to the micro-processing device 26 of the controller 2 via the wire 28. The micro-processing device 26 activates the thyristor member 24 to adjust the flow of the current passing therethrough so as to achieve the adjustment to the heating pad 1. In the meanwhile, the micro-processing device 26 of the controller 2 sends a signal that the thyristor member 24 is adjusted via the wire 28 to the temperature display member 33 of the switch 3. Along with the times that the user presses the temperature regulation button 32 in short manner, the thyristor member 24 is active to change the current passing therethrough, such that the heating pad 1 changes the heat it generates. The change is sent as a feedback to the temperature display member 33 of the switch 3 so that the temperature display member 33 displays the change of the temperature.

When the user wants to stop the operation of the heating pad 1, he or she simply presses the temperature regulation button 32 in long-pressing manner, the circuit board 31 and the wire 28 send the long-pressing signal to the micro-processing device 26 of the controller 2. The micro-processing device 26 then closes the thyristor member 24 to stop the current from passing through the heating pad 1 via the thyristor member 24 and the wire 28. In the meanwhile, the micro-processing device 26 of the controller 2 sends a signal that the thyristor member 24 is closed is sent to the switch 3 and the status is displayed by shutting off the temperature display member 33 of the switch 3. Therefore, the user is acknowledged that the status of the heating pad 1.

The heating device is connected to the suit 4 so that when the user feel cold, he or she connects the power input member 22 to the battery of the motorcycle to activate the heating device to warm the user's body. Because the switch 3 is light and can be conveniently connected to the sleeve, front chest portion or the lower portion of the suit 4, so that the user can easily operate the switch 3 without need to stop the motorcycle. The present invention provides at least one current output member 27 which is used to provide temperature to mittens, pants and shoes.

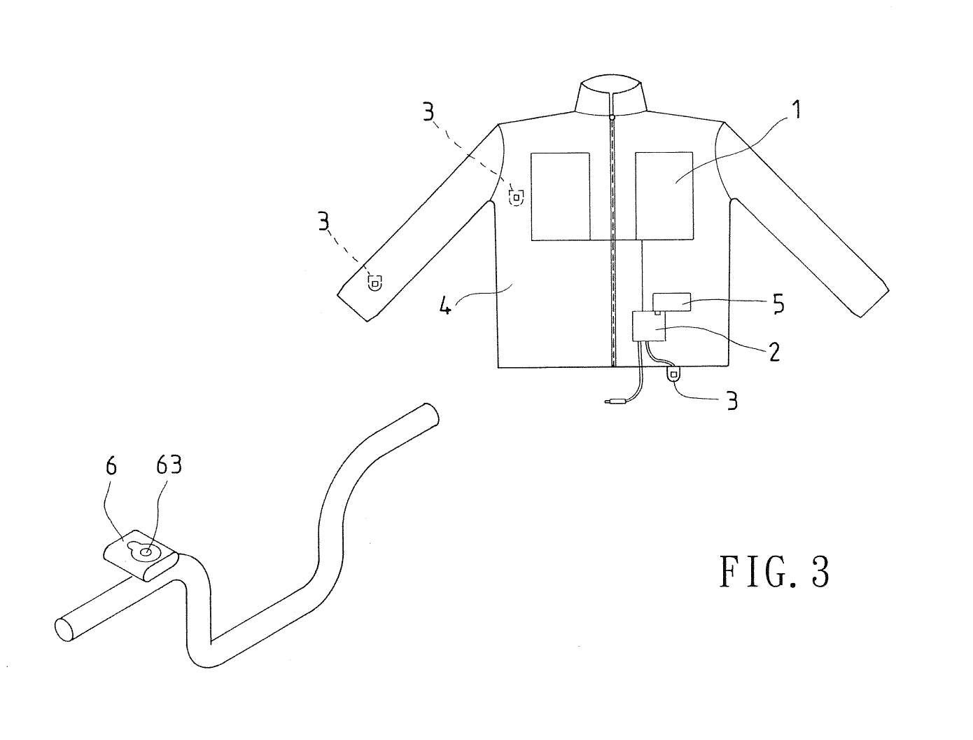

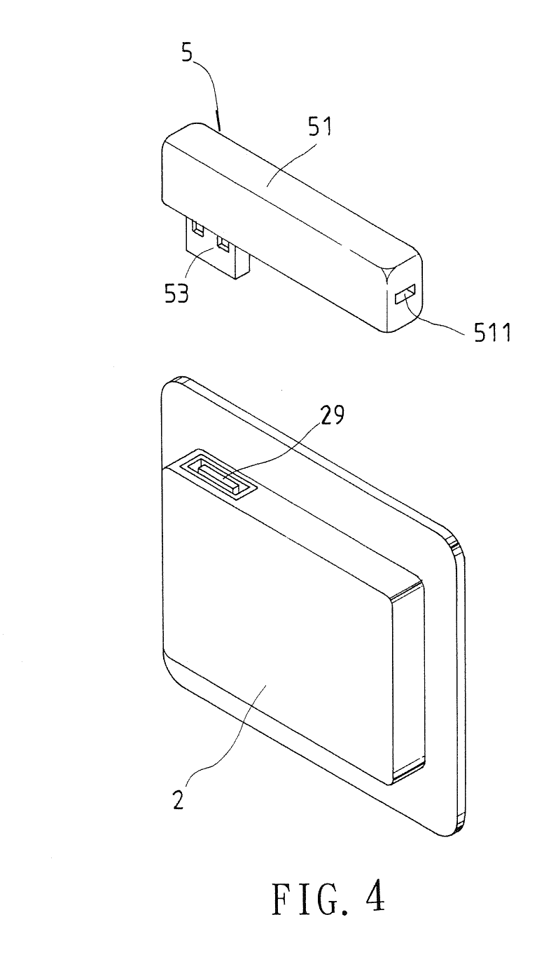

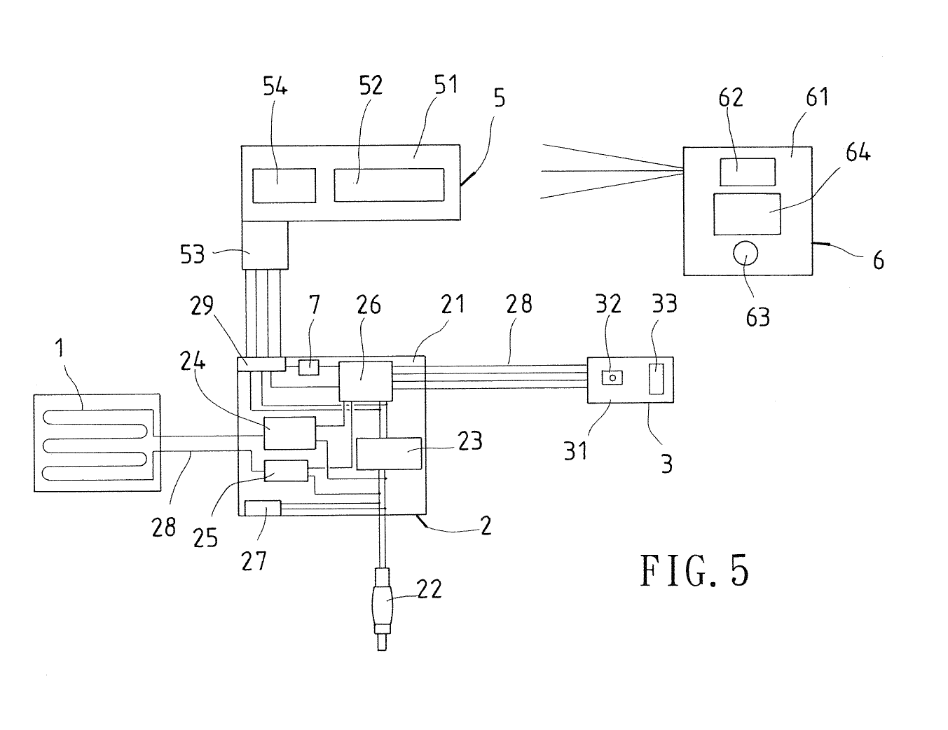

As shown in FIGS. 3 to 5, the second embodiment of the present invention provides a signal input member 29 which is in the form of a USB and connected to the circuit board 21 of the controller 2. The signal input member 29 is connected to a decoder 7 which is connected to the micro-processing device 26 of the controller 2. A signal receiver 5 is provided for receiving wireless radio frequency (rf) signals and has a signal receiving member 52. The signal receiver 5 has a signal output member 53 which is in the form of a USB which is connected to the signal receiving member 52. The signal input member 29 is connected to the signal output member 53 by connecting the respective USBs. The signal receiver 5 has a buzzer 54 located in a case 51 thereof and the sound can be sent via holes 511 defined through the case 51. A signal emitter 6 for emitting wireless radio frequency (rf) signals is connected the inside of a case 61 of the signal emitter 6 and has a signal emitting member 62. A temperature regulation member 63 and a temperature display member 64 are connected to the case 61 so as to be connected with the signal emitting member 62. A C-shaped clip is used to secure the case 61 to the handle of the motorcycle so that the user can easily access the temperature regulation member 63 of the signal emitter 6 to activate the heating pad 1. By pressing the signal emitter 6, the signal emitting member 62 sends the rf signal to regulate the temperature, and the signal receiving member 52 of the signal receiver 5 receives the rf signal and transfers the rf signal to the signal input member 29 of the controller 2. The rf signal is then decoded by the decoder 7 and decoded signal is sent to the micro-processing device 26 of the controller 2 to drive the thyristor member 24 to control the current passing through the heating pad 1. When the user presses the temperature regulation member 63 of the signal emitter 6, the temperature display member 64 displays the corresponding signal. In the meanwhile, when the signal receiver 5 receives the signal, the buzzer 54 generates a sound which passes through the holes 511 so that the user is acknowledged by the lights of the temperature display member 64.

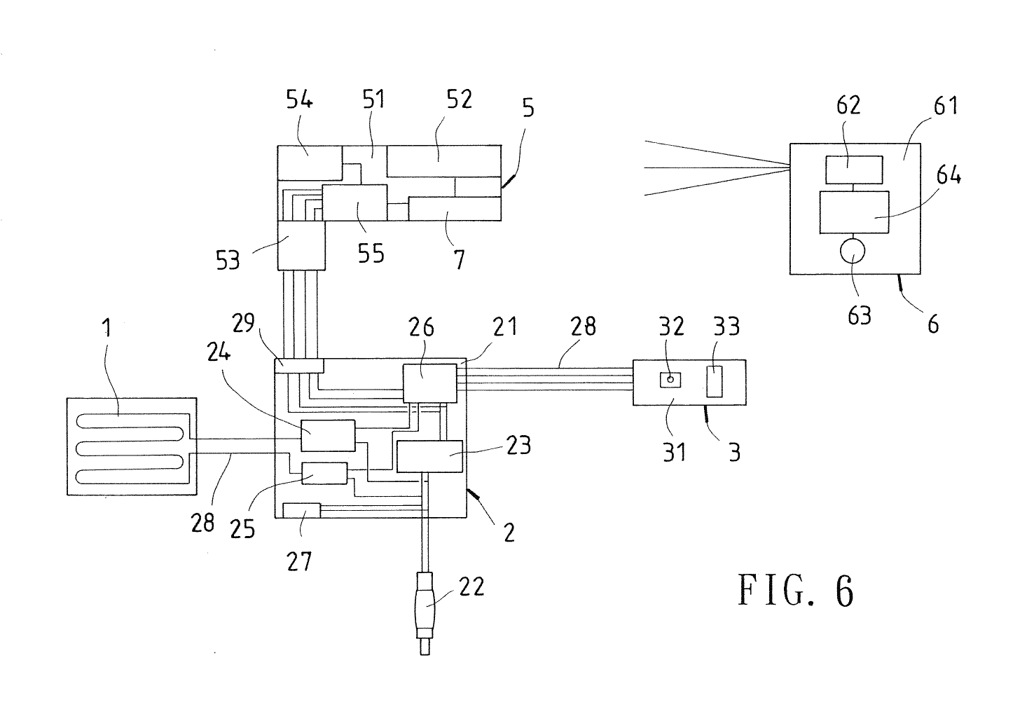

As shown in FIG. 6, the decoder 7 is located in the case 51 of the signal receiver 5 and is connected with the signal receiving member 52 of the signal receiver 5. A signal micro-processing member 55 is located in the case 51 of the signal receiver 5 and connected to the decoder 7 and the signal output member 53. The micro-processing device 26 is connected to the signal input member 29 of the controller 2. When the signal receiving member 52 receives the rf signal sent by the signal emitter 6, the rf signal is decoded by the decoder 7 and transferred to the signal micro-processing member 55. The signal micro-processing member 55 sends the decoded signal to the signal input member 29 via the signal output member 53. The decoded signal is then sent to the micro-processing device 26 which closes or opens the thyristor member 24 according to the received signal so as to control the operation of the heating pad 1. Alternatively, the signal receiving member 52, the buzzer 54 and the decoder 7 can be directly connected to the circuit board 21 of the controller 2 so as to connect the decoder 7 to the micro-processing device 26, and the signal receiving member 52 is connected to the buzzer 54 so as to adjust the temperature of the heating pad 1 according the signal received from the signal emitter 6.

While we have shown and described the embodiment in accordance with the present invention, it should be clear to those skilled in the art that further embodiments may be made without departing from the scope of the present invention.

What is claimed is:

1. A heating device comprising:
a heating pad adapted to be installed in a suit;
a controller adapted to be fixed to the suit and having a circuit board, the circuit board connected with a power input member, a thyristor member which is connected to the power input member, the thyristor member connected with the heating pad by a wire, a micro-processing device connected to the circuit board and connected with the thyristor member and the power input member, the micro-processing device connected to a circuit board of a switch by a wire, the wire connected between the controller and the switch and the wire connected between the controller and the heating pad being adapted to be located in the suit, and
the switch located separated from the controller and adapted to be connected to the suit, the circuit board of the switch having a temperature regulation button and a temperature display member connected thereto, the temperature regulation button and the temperature display member connected to the micro-processing device of the controller by the circuit board of the switch.

2. The heating device as claimed in claim 1, wherein the circuit board of the controller has at least one power output member which is connected to the power input member.

3. The heating device as claimed in claim 1, wherein the circuit board of the controller has a current detection member connected thereto which is connected with the power input member, the wire is connected between the current detection member and the heating pad, the wire connected between the current detection member and the heating pad is adapted to be located in the suit.

4. The heating device as claimed in claim 1, wherein the circuit board of the controller has a voltage reduction member connected thereto which is connected between the power input member and the micro-processing device.

5. The heating device as claimed in claim 1, wherein the circuit board of the controller has a signal receiving member and a decoder of a signal receiver, the signal receiving member is connected to the decoder which is connected to the micro-processing device of the controller, a signal emitter is connected to the signal receiving member of the signal receiver, a temperature display member is connected to the signal emitter.

6. The heating device as claimed in claim 5, wherein the signal receiver has a buzzer connected thereto and is connected to the circuit board of the controller, the buzzer is connected to the signal receiving member.

7. The heating device as claimed in claim 1, wherein the circuit board of the controller has a signal input member and a decoder which is connected to the signal input member, the decoder which is connected to the micro-processing device of the controller, a signal receiver has a signal receiving member and a signal output member which is connected to the signal input member of the controller, a signal emitter is connected to the signal receiving member of the signal receiver and a temperature display member is connected to the signal emitter.

8. The heating device as claimed in claim 7, wherein the signal receiver has a buzzer which is connected to the signal receiving member.

9. The heating device as claimed in claim 1, wherein the circuit board of the controller has a signal input member which is connected to the micro-processing device of the controller, a signal receiver has a signal receiving member, a decoder, a signal micro-processing member and a signal output member, the signal receiving member is connected to the decoder which is connected to the signal micro-processing member, the signal micro-processing member is connected to the signal output member which is connected to the signal input member of the controller, a signal emitter is connected to the signal receiving member of the signal emitter, a temperature display member is connected to the signal emitter.

10. The heating device as claimed in claim 9, wherein the signal receiver has a buzzer which is connected to the signal receiving member.
